(19) United States
(12) Patent Application Publication
(10) Pub. No.: US 2016/0176741 A1
(43) Pub. Date: Jun. 23, 2016

(54) METHODS AND SYSTEMS FOR TREATING WASTEWATER FROM INDUCED HYDRAULIC FRACTURING

(71) Applicant: University of Pittsburgh-Of The Commomwealth System of Higher Education, Pittsburgh, PA (US)

(72) Inventor: DI GAO, Sewickley, PA (US)

(73) Assignee: University of Pittsburgh- Of The Commonwealth System Of Higher Education, Pittsburgh, PA (US)

(21) Appl. No.: 14/911,061

(22) PCT Filed: Aug. 8, 2014
(86) PCT No.: PCT/US14/50249

§ 371 Date: Feb. 9, 2016

Related U.S. Application Data
(60) Provisional application No. 61/864,421, filed on Aug. 9, 2013.

(51) Int. Cl. C02F 9/00; C02F 1/66; C02F 1/52; C02F 1/40; B01D 17/02; B01D 21/01; C02F 1/463; C02F 1/02

(52) U.S. Cl. CPC C02F 9/00; C02F 1/463; C02F 1/66; C02F 1/02; C02F 1/40; B01D 17/0208; B01D 21/01; C02F 1/52; C02F 2001/007

(57) ABSTRACT

A system for treating waste water includes a waste water inlet, a pretreatment system in fluid communication with the waste water inlet, which is adapted to reduce the concentration of at least one of suspended solids, oil and grease, and a crystallization system downstream of the pretreatment system. A method for treating waste water include introducing the waste water into a pretreatment system being adapted to reduce the concentration of at least one of suspended solids, oil and grease, and introducing liquid effluent from the pretreatment system to a crystallization system.

### CROSS-REFERENCE TO RELATED APPLICATIONS

This application claims benefit of U.S. Provisional Patent Application Ser. No. 61/864,421, filed Aug. 9, 2013, the disclosure of which is incorporated herein by reference.

### BACKGROUND INFORMATION

Induced hydraulic fracturing, often shortened to fracking, fracing, or hydrofracing, is a formation stimulation technique used to create permeability in a reservoir by inducing propagation of fractures caused by the presence of a pressurized fluid. Reservoirs are typically porous sandstones, limestones, or dolomite rocks, but also include unconventional reservoirs such as shale rock or coal beds. Induced hydraulic fracturing, known colloquially as a “frac job”, creates fractures from a wellbore drilled into reservoir formations and provides a conductive path connecting a larger area of the reservoir to the well, thereby increasing the area from which oil and natural gas can be recovered from the targeted formation and allowing oil, natural gas (including shale gas, tight gas and coal seam gas), or other substances to flow more readily to the wellbore.

Induced hydraulic fracturing utilizes and produces large amount of fluids during drilling operations and during the years of production. Low-volume hydraulic fracturing that is used to stimulate high-permeability reservoirs may consume typically 20,000 to 80,000 US gallons of water per well, and high-volume hydraulic fracturing that is used in the completion of tight gas and shale gas wells can use as much as 3 to 5 million US gallons of water per well. After a hydraulic fracture treatment, when the pumping pressure has been relieved from the well, the water-based fracturing fluids begin to flow back through the well casing to the wellhead. This fluid is referred to as flowback water and contains spent fracturing fluids and dissolved constituents from the formation itself (e.g., minerals as well as brine waters that may be present in the formation). The production of flowback water can continue for a range of time from several hours to a couple of weeks, and in some cases, several months. In addition to flowback water, natural formation water also flows to the well, known as the produced water. The fluid produced back through the wellhead with the gas and/or oil represents a production stream that must be managed.

It is a priority concern of local, state and federal government agencies, that tens of millions of gallons of fresh water are removed each month from the water table and permanently contaminated. A practice in the prior art has been to simply discharge this contaminated water in reserve pits, but such practice has been prohibited in many areas. Another practice in the prior art is to temporarily store the contaminated water in tanks and then send it to deep “disposal” wells, which have been drilled for the specific purpose of eliminating potential environmental liabilities for the oil companies. The water sent to deep “disposal” wells will never be available for future use. This method of disposal is expensive, wasteful, and also contains environmental risk.

Because of concerns over the shortage and cost of water available for hydraulic fracing, as well as the environmental risk, the need to treat and recycle the contaminated water for re-use in the fracing process, for agricultural use, and/or for discharge into the waterways has become apparent in the fracing industry. However, finding a water treatment process that is technically and economically viable for such purposes has proven challenging, partly because of the complex mixture of chemicals and high levels of dissolved solid contained in the contaminated water. For example, the concentration of the total dissolved solids (also referred to herein as “TDS”) in the flowback water produced in the Bakken oil fields (BOF) can be as high as 250,000 ppm. Current water treatment processes, including a variety of water treatment technologies such as flotation, coagulation, filtration, evaporation, reverse osmosis, and combinations of these technologies, have been applied to treat the flowback water generated in BOF, but none of them have been able to adequately treat the water for its re-use in the fracing process. In general, none of these processes are able to reduce the TDS level of the contaminated water to a satisfactory level for re-use in the fracing process.

### SUMMARY OF THE DISCLOSURE

In a number of embodiments, methods and systems are provided for treating water such as flowback water and produced water generated (also collectively referred to herein as “waste water”) in the hydraulic fracing process, which typically contains spent fracturing fluids and dissolved constituents from the formation. In that regard, a system for treating waste water includes a waste water inlet, a pretreatment system in fluid connection with the waste water inlet, which is adapted to reduce the concentration of at least one of suspended solids, oil and grease, and a crystallization system downstream of the pretreatment system. The pretreatment system may, for example, be adapted to reduce the concentration of each of suspended solids, oil and gas. Water separated from sludge generated in the pretreatment system may, for example, be recycled to the system. Likewise, water separated from a concentrate generated in the crystallization system may be recycled to the system. In a number of embodiments, the pretreatment system includes at least one of an electrocoagulation system, a system for adding precipitating agents and flocculating agents followed by clarification, or a membrane filtration system. In a number of embodiments, the system further includes a system adapted to adjust the pH of waste water entering the pretreatment system.

In a number of embodiments, the crystallization system includes a supersaturation generation system. The supersaturation generation system may, for example, include a heating source. The crystallization system may also include a magma recirculation system to control supersaturation generation. In a number of embodiments, the crystallization system is configured such that a mixed suspension is provided as an active volume for relieving the supersaturation. The crystallization system may, for example, be configured to be operated in a metastable zone of a solute-solvent system (that is, of the solute-solvent system corresponding to the influent introduced to the crystallization system). The concentrate from the crystallization system may, for example, be directed to a dewatering unit selected from the group consisting of a filter press system, centrifuge system, and an electro-dewatering system.

In a number of embodiments, the pretreatment system includes the electrocoagulation system, and removed contaminants from the electrocoagulation system are fed into a sludge concentrator selected from the group consisting of a filter press system, a centrifuge system, and an electro-dewatering system. The system may further include a gravity separation unit for use in separating floating oil, floating grease or heavy suspended solids from the waste water before the waste water enters the at least one of the electrocoagulation system, the system for adding precipitating agents and flocculating agents followed by clarification, or the membrane filtration system (or other system for reducing the concentration of oil, floating grease and/or heavy solids). The gravity separation unit may, for example, include a baffled bank system, an oil-decanting port and a solid removal port. In a number of embodiments, the system further includes a centrifugal separation unit located upstream of the at least one of the electrocoagulation system, the system for adding precipitating agents and flocculating agents followed by clarification, or the membrane filtration system (or other system for reducing the concentration of oil, floating grease and/or heavy solids). The system may further include a filtration unit located downstream of the at least one of the electrocoagulation system, the system for adding precipitating agents and flocculating agents followed by clarification, or the membrane filtration system (or other system for reducing the concentration of oil, floating grease and/or heavy solids) but before the crystallization system.

In a number of embodiments, the system for adding precipitating agents and flocculating agents includes a mixing tank connected to a precipitating tank from which precipitating agents are injected, and is connected to a flocculating agent tank from which a flocculating agent is injected. The flocculating agent may, for example, include one or more anionic water soluble polymers.

A method for treating waste water includes introducing the waste water into a pretreatment system being adapted to reduce the concentration of at least one of suspended solids, oil and grease, and introducing liquid effluent from the pretreatment system to a crystallization system. In a number of embodiments, the method further includes recycling water separated from sludge generated in the pretreatment system to the waste water introduced into the pretreatment system, or to another inlet. Likewise, the method may further include recycling water separated from a concentrate generated in the crystallization system to the crystallization system or to another inlet. In a number of embodiments, the pretreatment system includes at least one of an electrocoagulation system, a system for adding precipitating agents and flocculating agents followed by clarification, or a membrane filtration system. The method may, for example, further include adjusting the pH of waste water before it enters the pretreatment system.

The method may, for example, include crystallizing a solute by providing a heating source to remove solvent from the liquid in the crystallization system. The method may further include controlling supersaturation generation using a magma recirculation system. In a number of embodiments, the method further includes providing a mixed suspension as an active volume for relieving supersaturation. In a number of embodiments, operating conditions during heating are within a metastable zone of a solute-solvent system in the crystallization system for a period of time. The concentrate from the crystallization system may, for example, be directed to a dewatering unit or system. The dewatering unit or system may, for example, be selected from the group consisting of a filter press system, a centrifuge system, and an electro-dewatering system.

The method may further include directing removed contaminants from the electrocoagulation system into a sludge concentrator selected, for example, from the group consisting of a filter press system, a centrifuge system, and an electro-dewatering system. In a number of embodiments, the method further includes separating at least one of floating oil, floating grease and or suspended solids from the waste water using a gravity separation system before the waste water enters the at least one of the electrocoagulation system, the system for adding precipitating agents and flocculating agents followed by clarification, or the membrane filtration system (or other system for reducing the concentration of oil, floating grease and/or heavy solids). The gravity separation system may, for example, include a baffled bank system, an oil-decanting port and a solid removal port. In a number of embodiments, the method further includes directing the waste water to a centrifugal separation system before it enters the at least one of the electrocoagulation system, the system for adding precipitating agents and flocculating agents followed by clarification, or the membrane filtration system (or other system for reducing the concentration of oil, floating grease and/or heavy solids).

The method may, for example, further include filtering effluent from the pretreatment system before it enters the crystallization system. In a number of embodiments, the method further includes adding precipitating agents to a mixing tank with the waste water and adding flocculating agent to the mixing tank. The flocculating agent may, for example, include at least one anionic water soluble polymer.

As described above, in a number of embodiments, the waste water for treatment in the systems and/or methods hereof is waste water from a hydraulic fracturing process. The treatment methods and systems hereof may, for example, allow for re-use of the treated water for fracing process, and/or recycling of the treated water for agricultural, industrial, municipal and/or other use. In a number of embodiments, the treatment systems and/or methods hereof provide for substantially zero liquid discharge, meaning that substantially no waste is discharged in a liquid form (for example, up to at least 95%, at least 97% or even at least 99% of water can be recycled and reused in a number of embodiments hereof).

In a number of embodiments hereof, water treatment systems or methods hereof may be modularized. For example, the pretreatment system/process and/or the crystallization system/process, may be carried out by two or more functional modules. Individual modules may, for example, be assembled and installed on-site near the drilling wells to treat waste water from individual wells, and/or be installed and utilized in a central processing facility in a strategic location for treating waste water from several wells. Each module of the water treatment system/process may, for example, be skid mounted and suitable for operations in remote areas.

### BRIEF DESCRIPTION OF THE DRAWINGS

FIG. 1 is a schematic illustration or an embodiment of a method and system hereof including two water treatment processes.

FIG. 2 is a schematic illustration of an embodiment of a modified water treatment method and system, in which the sludge from a first treatment process and from a second treatment process is processed through a dewatering unit, and the water separated from the sludge is recycled to the influent.

FIG. 3 is a schematic illustration of an embodiment of a first or pretreatment process based on an electrocoagulation technology.

FIG. 4 is a schematic illustration of an embodiment of a modified method or system based on the process shown in FIG. 3, including a number of optional units.

FIG. 5 is a schematic illustration an embodiment of a pretreatment process including the addition of precipitating agents and flocculating agents followed by clarification.

FIG. 6 is a schematic illustration of an embodiment of a modified method or system based upon the process shown in FIG. 5, with a number of optional units, for some embodiments of the present disclosure.

FIG. 7 is a schematic illustration of an embodiment of a pretreatment process including use of membrane filtration technologies.

FIG. 8 is a schematic illustration of an embodiment of a modified method or system based upon the process shown in FIG. 7, further including a number of optional units.

FIG. 9 is an illustration of a general solid-liquid thermodynamic phase diagram of a solute-solvent system that is used to illustrate a mechanism of a crystallization process hereof.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein in the specification and claims, including as used in the examples and unless otherwise expressly specified, all numbers may be read as if prefaced by the word “about”, even if the term does not expressly appear, unless otherwise expressly stated or clear from the context. In the present description, where used or otherwise designated to apply as described above, the term “about” mean ±20% of the indicated range, value, or structure, unless otherwise indicated of clear from the context.

As used herein and in the appended claims, the singular forms “a,” “an”, and “the” include plural references unless the context clearly dictates otherwise. Thus, for example, reference to “a unit” includes a plurality of such units and equivalents thereof known to those skilled in the art, and so forth, and reference to “the unit” is a reference to one or more such units and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

The use of the alternative (e.g., “or”) should be understood to mean either one, both, or any combination thereof of the alternatives, unless otherwise expressly indicated. As used herein, the terms “include” and “comprise” are used synonymously, and those terms, and variants thereof, are intended to be construed as non-limiting unless otherwise expressly stated.

In the following description, certain specific details are set forth to provide a thorough understanding of various embodiments of the disclosure. However, upon reviewing this disclosure one skilled in the art will understand that the disclosure may be practiced without many of these details.

Whenever the terms, “for example,” “such as,” or variants thereof are used herein, the provided examples are assumed to be without limitation or restriction, unless otherwise expressly indicated.

In a number of embodiments, methods, processes and systems for treating contaminated water, including, for example, flowback water and produced water generated from induced hydraulic fracturing, are described. In the case of hydraulic fracturing, water to be treated typically contains spent fracturing fluids and dissolved constituents from the formation. Water treatment methods and systems for treating flowback water and produced water from fracing hereof can reduce levels of TDS, total suspended solids (also referred to herein as “TSS”), and oil and grease (also referred to herein as “O&G”), while lowering chemical oxygen demand (COD), biochemical oxygen demand (BOD) and total organic carbon (TOC) levels, so that the treated water can be reclaimed for use in the fracing process, and/or recycled for agricultural, industrial, municipal, or other use. In a number of embodiments, the methods, processes and systems hereof allow for more than 99% of water to be recycled and/or reused in, for example, the fracing process.

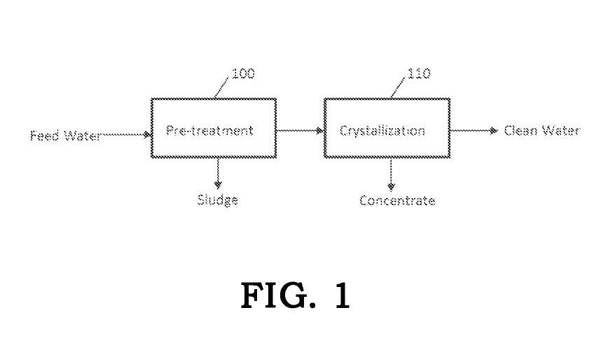

In a number of embodiments, methods hereof include two treatment processes, such as shown in FIG. 1. The first process is sometimes referred to herein as a pretreatment process 100 that removes (that is, reduces the concentration of) suspended solids, oil and/or grease. Process 100 may be effected in one of more devices, systems or units which may also sometimes be referred to herein as system or unit 100. The removed suspended solids and oil and grease are discharged from process 100 in the form of sludge. The TSS level of the effluent from process 100 can be, for example, less than 1000 ppm, less than 200 ppm, or less than 50 ppm. The O&G level of the effluent from process 100 can be less than 100 ppm, less than 20 ppm or less than 10 ppm.

The effluent from process 100 is directed to a second treatment process or system 110 which can remove dissolved solids through a crystallization process. The second treatment process 110 separates the dissolved solids from water, which is discharged in the form of a concentrate. The TSS level of the effluent from treatment process 110 can, for example, be less than 10 ppm, less than 5 ppm or less than 2 ppm. The O&G level of the effluent from treatment process 110 can be less than 10 ppm, less than 2 ppm or less than 1 ppm. The TDS of the effluent from treatment process 110 can, for example, be less than 500 ppm, less than 250 ppm or less than 50 ppm.

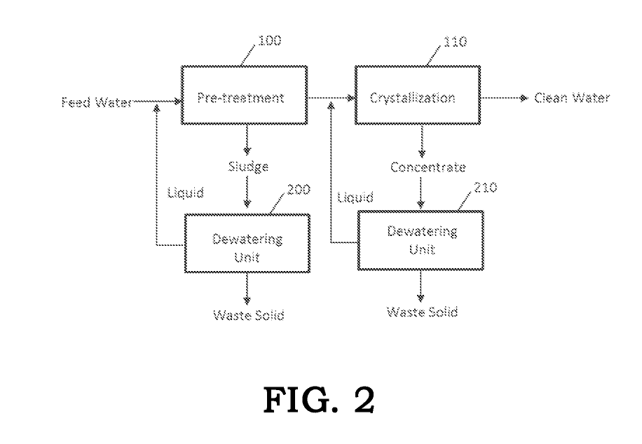

In some embodiments, sludge from first treatment process 100 and/or the second treatment process 110 may be processed through a dewatering unit, and the water separated from the sludge is recycled to the influent. A representative embodiment of such a modified treatment process is illustrated in FIG. 2.

In a number of embodiments, the sludge from first treatment process 100 is directed to a dewatering unit 200 and is separated into a liquid stream and a waste solid, typically in the form of a cake. The liquid stream is recycled through a return line and mixed with the influent feed to first treatment process/unit 100. Dewatering unit 200 may be chosen from various types of dewatering units or systems including, for example, filter press systems, centrifuge systems, and/or electro-dewatering system.

In another representative embodiment, the concentrate from second treatment process 110 is directed to a dewatering unit 210 and separated into a liquid stream and a waste solid, typically in the form of a cake. The liquid stream is recycled through a return line and mixed with the influent feed to second treatment process/system 110. Dewatering unit 210 may be chosen from various types of dewatering units or systems including, for example, filter press systems, centrifuge systems, and/or electro-dewatering systems.

In a number of embodiments, by recycling the water separated from the sludge to the influent of the treatment process in each of treatment process 100 and treatment process 110, the entire treatment process/system hereof may be a zero liquid discharge system, meaning that no or substantially no waste is discharged in a liquid form from the treatment process. By doing so, up to 99% of water can be recycled and reused in a number of embodiments hereof.

As described above, first treatment process 100 may be a pretreatment process that primarily removes suspended solid and oil and grease. First treatment process 100 can, for example, be completed through various technologies and systems, including flocculation, coagulation, dissolved air floatation, microfiltration, electrocoagulation, clarifier, centrifuge, plate separators, hydro-cyclone and/or combination of these technologies and systems, as will be appreciated by those skilled in the art after reviewing this disclosure.

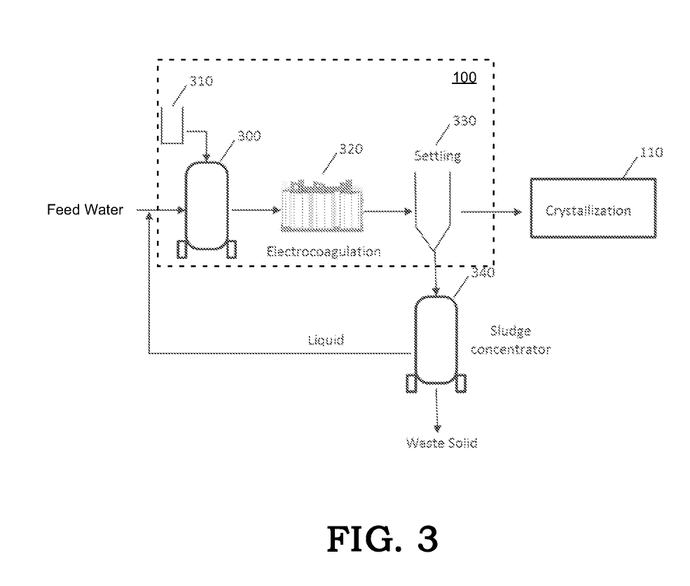

In a number of embodiments, first, pretreatment process 100 uses electrocoagulation technology and one or more electrocoagulation units or systems are used as pretreatment units/systems. FIG. 3 illustrates an example of an embodiment of system hereof including an electrocoagulation unit or system 300. The wastewater from the fracing process is fed into the system of FIG. 3 at an entry tank 300. Depending on the pH of the feed water, the pH of the water within entry tank 300 may be adjusted by a base stored in a storage tank 310. The pH range of the effluent of the entry tank 300 may, for example, be adjusted to be between 7 and 10. An example of a base for adjusting pH is sodium hydroxide. The base may be charged into entry tank 300 from the storage tank 310 by, for example, known automated control systems. This pH adjustment process is optional. When the pH of the feed water is, for example, between 7 and 10, the wastewater can be directed into electrocoagulation system 320 without being subjected to the pH adjustment process.

The water can then be pumped from the entry tank 300 to electrocoagulation unit or system 320. In a number of embodiments, electrocoagulation systems for use herein may include metal plates energized by a DC electrical current. As the contaminated water passes through the plates, charged ions are introduced into water from the plates, which neutralizes the charge on the surface of the oil and grease droplets and suspended solids. The charge neutralization causes these contaminants to coagulate, as will be appreciated by those skilled in the art after reviewing this disclosure. As water passes through the plates, heavy metal ions dissolved in water may be reduced to an oxide and precipitate out of water, changing from a dissolved state to a suspended state. In addition, oxygen and hydrogen gas may form during electrocoagulation, causing the coagulated contaminants to rise to the surface of water.

Effluent of electrocoagulation unit 320 can, for example, be directed to a settling tank 330, which is employed for removal of precipitated contaminants and coagulated contaminants. The resulting water can be directed to second treatment process 110 based on crystallization.

In a number of embodiments, the removed contaminants from electrocoagulation unit or system 320 are fed into a sludge concentrator 340, which can be basically a dewatering unit. The sludge is separated into a liquid stream and a waste solid, typically in the form of a cake. The liquid stream can be recycled through a return line and mixed with the feed water to entry tank 300. In a number of embodiments, dewatering unit or system 340 can be chosen from various types of dewatering units or system including, for example, filter press systems, centrifuge systems, and/or electro-dewatering systems.

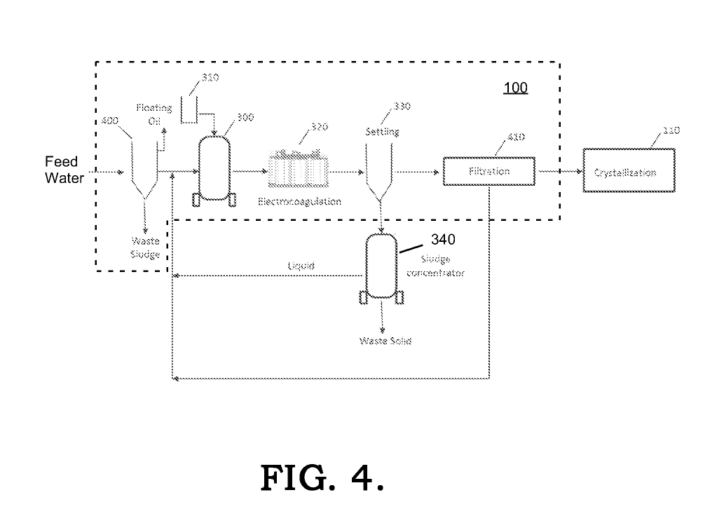

In a number of embodiments, pretreatment process 100, as shown in FIG. 3, can be modified to include other units. For example, referring to FIG. 4, prior to feeding water to the entry tank 300 and subjecting the water to pH adjustment, a separation unit or system 400 may be used to remove floating oil and grease and heavy suspended solids from the feed water. Such a separation unit can, for example, employ gravity separation, such as a baffled bank system, as will be appreciated by those skilled in the art after reviewing this disclosure. Separation unit 400 may, for example, contain an oil-decanting port for floating oil collection and a solid removal port for collecting settled solids/waste sludge. Optionally, centrifugal separation may also be employed to separate physically or chemically emulsified solids that do not naturally settle.

In some embodiments, a filtration unit or system 410 is provided between settling tank 330 and second treatment process 110 based on crystallization. Various types of media filters may be utilized, including, but not limited to, sand filter, and micro- and ultra-filtration unit. The waste stream can, for example, be recycled through a return line to be mixed with the influent feed water that is directed into entry tank 300.

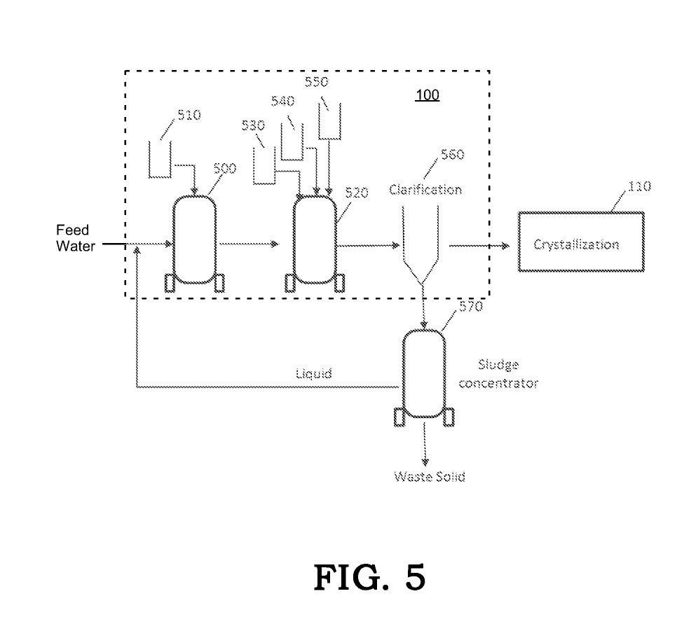

In a number of embodiments, first, pretreatment process 100 may comprise, in lieu of, or in addition to, an electrocoagulation system, a pretreatment unit or system comprising a mixing tank to which is added precipitating agents and/or flocculating agents, followed by a clarification tank/system. For example, FIG. 5 provides a simplified illustration of an embodiment of such a process. In the embodiment of FIG. 5, the wastewater from, for example, a fracing process can be fed into the system at an entry tank 500. Depending on the pH of the feed water, the pH of the water within entry tank 500 may be adjusted by an acid stored in a storage tank 510. For example, pH range of the effluent of the entry tank 500 may be between 2 and 5. An example of an acid for adjusting (increasing) pH is sulfuric acid. The acid can, for example, be charged into entry tank 500 from storage tank 510 by known automated control systems, as will be appreciated by those skilled in the art after reviewing this disclosure. The pH adjustment step can be optional. When the pH of the feed water is between 2 and 5, the wastewater can be directed into mixing tank 520 without being subjected to the pH adjustment process.

The water can then be pumped from entry tank 500 to a mixing tank 520. In mixing tank 520, precipitating agents such as, for example, ferric sulfate, sodium aluminate, and/or iron sulfate are charged into the water from a precipitating agent supply tank 530. An organic flocculating agent can be added to the mixing tank 520 from a flocculating agent supply tank 540. The organic polymeric flocculating agent can, for example, be an ionic water soluble polymer, such as, for example, polyacrylonitrile. In addition, polyacrylamide can, for example, be added to mixing tank 520 at a concentration of between 0.2% and 0.6% based on the weight of the feed wastewater. In other embodiments, the concentration of polyacrylamide can be above 0.6% or below 0.2%.

Effluent from mixing tank 520 can be directed to a clarification tank 560, which is employed for removal of precipitated contaminants and flocculated contaminants. The water can be fed into clarification tank 620 through piping to the bottom of the tank. The resulting water can be directed to second treatment process 110 involving crystallization.

In a number of embodiments, the removed contaminants from clarification tank 560 are fed into a sludge concentrator 570, which can be basically a dewatering unit. The sludge can be separated into a liquid stream and a waste solid, typically in the form of a cake. The liquid stream can be recycled through a return line and mixed with the feed water to entry tank 500. This dewatering unit may, for example, be chosen from various types of dewatering units or systems including, but not limited to, filter press systems, centrifuge systems, and/or electro-dewatering systems.

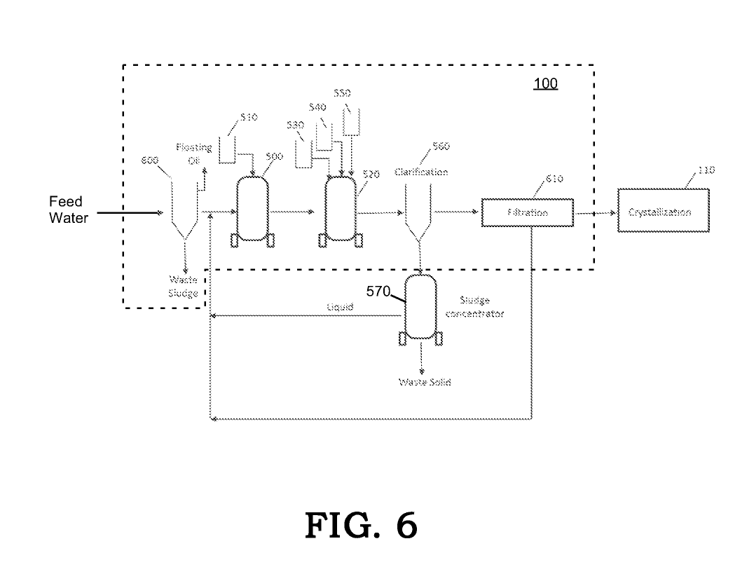

First or pretreatment process/system 100 as shown in FIG. 5 can, for example, be modified to include other units or systems in a number of embodiments. FIG. 6 illustrates a number of units that can be incorporated into the process. For example, prior to feeding water to entry tank 500 and subjecting the water to pH adjustment, a separation unit or system 600 may be used to remove floating oil, floating grease and/or heavy suspended solids from the feed water. Such a separation unit may, for example, employ gravity separation, such as a baffled bank system. The separation unit may contain an oil-decanting port for floating oil collection and a solid removal port for collecting settled solids. Optionally, centrifugal separation may also be employed to separate physically or chemically emulsified solids that do not naturally settle.

Another unit or system illustrated in FIG. 6 which can be used in a number of embodiments, is a filtration unit or system 610 between clarification tank 560 and second treatment process 110. Various types of media filters may be utilized, including, but not limited to, sand filter, and micro- and/or ultra-filtration units or systems. The waste stream can, for example, be recycled through a return line to be mixed with the influent feed water that is directed into entry tank 500.

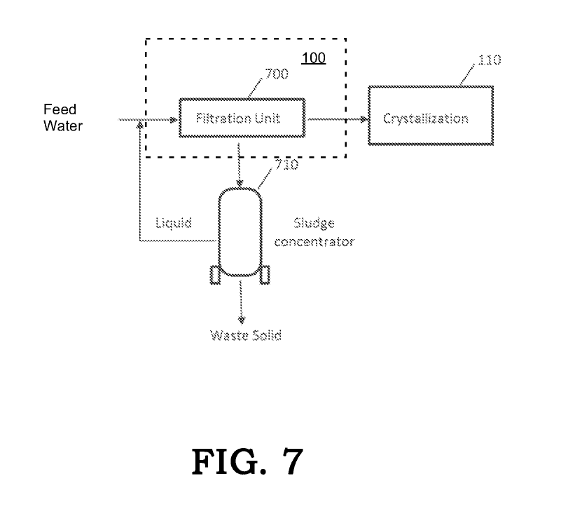

In a number of embodiments, first, pretreatment process 100 may also be carried out by using one or more membrane filtration units or systems, in lieu of an electrocoagulation system or the addition of precipitating agents and flocculating agents, or in addition to the same. FIG. 7 illustrates an embodiment of a process or system hereof in which a filtration unit or system 700 is used in process 100. The wastewater from the fracing process can, for example, be fed directly into filtration unit 700. Membrane filtration units or systems, including, for example, micro- and ultra-filtration units or systems, based on ceramic membranes that are able to remove suspended solids, oil and/or grease without using flocculants or coagulants are, for example, available in the art. In a number of embodiments, the removed contaminants from filtration unit 700 are fed into a sludge concentrator 710, which can be basically a dewatering unit. The sludge can, for example, be separated into a liquid stream and a waste solid, typically in the form of a cake. The liquid stream can be recycled through a return line and mixed with the feed water to filtration unit 700. The type of dewatering unit or system can be chosen from various types of dewatering units or systems including, for example, filter press systems, centrifuge, and electro-dewatering equipment.

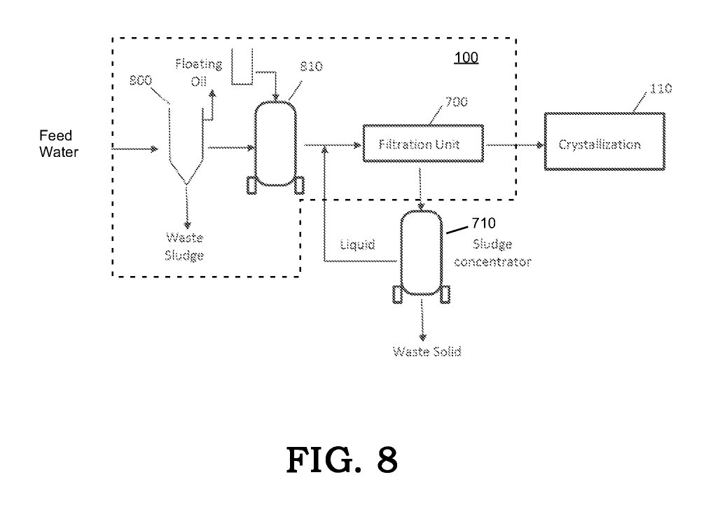

Pretreatment process 100 shown in FIG. 7 can, for example, be modified to include other units. FIG. 8 illustrates further representative embodiments of pretreatment process 100. For example, prior to feeding water to filtration unit 700, a separation unit or system 800 may be used to remove floating oil, floating grease and/or heavy suspended solids from the feed water. Separation unit 800 may, for example, employ gravity separation, such as, for example, a baffled bank system. Separation 800 unit may contain an oil-decanting port for floating oil collection and a solid removal port for collecting settled solids. Also, in the process illustrated in FIG. 8, a pH adjustment unit 810 can be provided prior to feeding water to filtration unit 700.

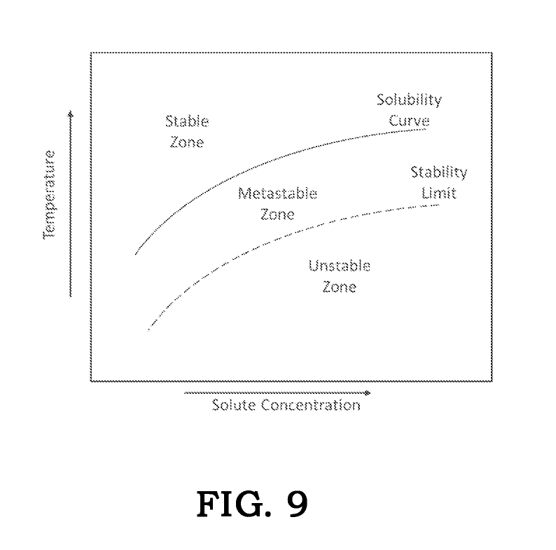

As described above, in a number of embodiments hereof, second treatment process 110 is carried out through a crystallization process. Without being bound by theory or any particular mechanism, to illustrate a mechanism of the crystallization process, FIG. 9 shows an example general solid-liquid thermodynamic phase diagram of a solute-solvent system. The solubility curve, shown as the solid line, represents the thermodynamic equilibrium between the liquid and solid phases. Above the solubility curve is the stable zone, where the solute is dissolved in the solvent and the solution stays as a stable unsaturated liquid. Solutions with a composition and temperature below the solubility curve are supersaturated and, from thermodynamic point of view, the system favors formation of a solid phase—i.e., it is thermodynamically favorable for the dissolved salt to precipitate out of the solution. However, formation of a new solid phase also creates an interface between the solid and liquid phases, which increases the free energy of the system. Therefore, the net change of the free energy of the system associated with formation of a solid phase in a solution will be determined by the temperature and the composition of the solution as well as the size of the nuclei. As a result, right below the solubility curve, there is a metastable zone, where nucleation sites are necessary to initiate the formation of a solid phase from a supersaturated solution. As the system further moves away from the solubility curve, i.e., as the temperature decreases or the concentration of the solute increases, the presence of nucleation sites is not a requirement for the formation of a solid phase, and the supersaturated liquid is subject to spontaneous nucleation and formation of a solid phase. This region is called the unstable zone. The boundary between the metastable zone and the unstable zone is known as the stability limit, shown as a dashed line in FIG. 9. In a number of embodiments hereof, the crystallization process involved in treatment process 110 is operated in the metastable zone of the solute-solvent system for at least a period of time.

The solids dissolved in water are transferred from the liquid phase to the solid phase through nucleation and growth. Nucleation refers to formation of new crystals, and growth refers to deposition of solid material on existing crystals.

The equipment, unit(s) or system(s) used in the crystallization process hereof may, for example, have a mechanism to generate supersaturation and one or more mechanisms to remove the formed solid phase from the system. The equipment, unit(s) or system(s) may, for example, also have one or more mechanisms to relieve the supersaturation and to control the supersaturation generation.

The mechanism(s) for generating supersaturation may, for example, rely on the changes in the solubility of the dissolved component in the solution as a function of temperature and concentration, which can, for example, be measured through solubility experiments and quantified using solubility curves and phase diagrams.

Supersaturation may be generated by several mechanisms, including but not limited to, cooling that results in decrease in temperature, evaporation that results in a decrease in solvent percentage, and adiabatic evaporative cooling that results in both decrease in temperature and decrease in solvent percentage.

In a number of embodiments hereof, supersaturation is generated by adding heat to the system. The waste water to be treated typically has a complex composition of dissolved solids, including salts of sodium, calcium, barium, boron, potassium, and strontium. The changes in the solubility of these dissolved solids as a function of temperature is complex. A representative example of a suitable mechanism to generate supersaturation is to remove solvent by adding heat to the system.

In a number of embodiments, the system or equipment in which the crystallization process is carried out provides a mixed suspension as the active volume for relieving the supersaturation. In a number of embodiments, the system or equipment that carries out the crystallization process employs magma recirculation to control supersaturation generation.

In a number of representative embodiments, the water treatment systems hereof are modularized. The pretreatment process/system and the crystallization process/system may, for example, be completed by two functional modules. The individual modules may, for example, be assembled and installed on-site, near the drilling wells to treat wastewater from individual wells, or installed and utilized in a central processing facility in a strategic location for treating wastewater from a plurality of wells. Each module of the water treatment process may, for example, skid mounted and be suitable for operations in remote areas.

### Working Example

The following representative example is intended to be illustrative and should not be construed as limiting the disclosure in any way.

This example uses a water treatment system constructed following the schemes shown in FIG. 3 to treat flowback water. The characteristics of the flowback water emanating from a hydraulic fracing process are presented in Table 1.

TABLE 1
Characteristics of the flowback water emanating from
a hydraulic fracing process.

| Water Quality | | |
|---|---|---|
| Parameters | Unit | Value |
| pH | | 6.10 |
| Aerobic Plate Count | CFU/ml | 9.00 |
| Specific Conductance | μS/cm | 250,500 |
| Total Suspended Solids | mg/l | 712 |
| Total Alkalinity | mg/l CaCO₃ | 197 |
| Phenolphthalein Alk | mg/l CaCO₃ | <20 |
| Bicarbonate | mg/l CaCO₃ | 197 |
| Carbonate | mg/l CaCO₃ | <20 |
| Hydroxide | mg/l CaCO₃ | 0.00 |
| Chemical Oxygen Demand | mg/l | 3,550 |
| Total Dissolved Solids | mg/l | 269,000 |
| Total Organic Carbon | mg/l | 1,200 |
| Total Hardness as CaCO₃ | mg/l | 54,700 |
| Hardness in grains/gallon | gr/gal | 3,200 |
| Cation Summation | meq/L | 4,630 |
| Anion Summation | meq/L | 4,410 |
| Percent Error | % | 2.35 |
| Sodium Absorption Ratio | | 141.00 |
| Fluoride | mg/l | 1.35 |
| Sulfate | mg/l | 417 |
| Chloride | mg/l | 156,000 |
| Nitrate-Nitrate as N | mg/l | <0.5 |
| Oil & Grease | mg/l | 18.2 |
| Total Sulfides | mg/l | 4.2 |
| Calcium -Total | mg/l | 19,900 |
| Magnesium - Total | mg/l | 1,220 |
| Sodium - Total | mg/l | 76,000 |
| Potassium - Total | mg/l | 8,510 |
| Barium - Total | mg/l | 41.20 |
| Iron - Total | mg/l | 228 |
| Manganese - Total | mg/l | 15.00 |
| Strontium - Total | mg/l | 1,880 |
| Boron - Total | mg/l | 499 |

The flowback water was fed into the system at an entry tank. The pH of the water within the entry tank was adjusted by adding sodium hydroxide, so that the pH of the effluent from the entry tank was between 7.8 and 8.2. The water was then pumped from the entry tank to an electrocoagulation unit. Effluent of the electrocoagulation unit was directed to a settling tank, which was employed for removal of precipitated contaminants and coagulated contaminants. The characteristics of the effluent of the settling tank after the electrocoagulation process are listed in Table 2.

TABLE 2
Characteristics of the effluent from the settling tank after the
electrocoagulation process.

| Water Quality Parameters | Unit | Value |
|---|---|---|
| pH | | 7.90 |
| Aerobic Plate Count | CFU/ml | 10.00 |
| Specific Conductance | μS/cm | 168,000 |
| Total Suspended Solids | mg/l | 192 |
| Total Alkalinity | mg/l CaCO₃ | 1,120 |
| Phenolphthalein Alk | mg/l CaCO₃ | <20 |
| Bicarbonate | mg/l CaCO₃ | 1,120 |
| Carbonate | mg/l CaCO₃ | <20 |
| Hydroxide | mg/l CaCO₃ | 0.00 |
| Total Dissolved Solids | mg/l | 262,000 |
| Total Organic Carbon | mg/l | 220 |
| Total Hardness as CaCO₃ | mg/l | 56,800 |
| Hardness in grains/gallon | gr/gal | 3,320 |
| Cation Summation | meq/L | 3,470 |
| Anion Summation | meq/L | 4,840 |
| Sodium Absorption Ratio | | 91.80 |
| Fluoride | mg/l | <0.1 |
| Sulfate | mg/l | 868 |
| Chloride | mg/l | 170,000 |
| Nitrate-Nitrate as N | mg/l | 0.18 |
| Oil & Grease | mg/l | 2.70 |
| Total Sulfides | mg/l | <1 |
| Calcium - Total | mg/l | 21,000 |
| Magnesium - Total | mg/l | 1,060 |
| Sodium - Total | mg/l | 50,300 |
| Potassium - Total | mg/l | 5,930 |
| Barium - Total | mg/l | 18.50 |
| Iron - Total | mg/l | <5 |
| Manganese - Total | mg/l | <2.5 |
| Strontium - Total | mg/l | 1,780 |
| Boron - Total | mg/l | 276 |

The effluent of the settling tank after the electrocoagulation process was directed to the second-step treatment process. The second-step treatment process was completed through a crystallization process, which was operated in the metastable zone of the solute-solvent system. Supersaturation in the crystallization process was induced by bringing the mixture into contact with 0.13 MPa saturated steam. The apparatus that was used to carry out the crystallization process provided a mixed suspension as the active volume for relieving the supersaturation and employed magma recirculation to control supersaturation generation. The characteristics of the effluent from the crystallization process are listed in Table 3.

TABLE 3
Characteristics of the effluent from the crystallization process.

| Water Quality | | |
|---|---|---|
| Parameters | Unit | Value |
| pH | | 9.5 |
| Aerobic Plate Count | CFU/ml | 4 |
| Specific Conductance | μS/cm | 120 |
| Total Suspended Solids | mg/l | 2 |
| Total Alkalinity | mg/l CaCO₃ | 173 |
| Phenolphthalein Alk | mg/l CaCO₃ | 126 |
| Bicarbonate | mg/l CaCO₃ | <20 |
| Carbonate | mg/l CaCO₃ | 94 |
| Hydroxide | mg/l CaCO₃ | 79 |
| Chemical Oxygen | | |
| Demand | mg/l | 166 |
| Total Dissolved Solids | mg/l | <5 |
| Total Dis Solids | mg/l | 109 |
| (Summation) | | |
| Total Organic Carbon | mg/l | 65 |
| Total Hardness as | mg/l | <6.62 |
| CaCO₃ | | |
| Hardness in | gr/gal | <0.1 |
| grains/gallon | | |
| Cation Summation | meq/L | 0 |
| Anion Summation | meq/L | 3.46 |
| Sodium Absorption | | 0.17 |
| Ratio | | |
| Fluoride | mg/l | <0.1 |
| Sulfate | mg/l | 5.34 |
| Chloride | mg/l | <1 |
| Nitrate-Nitrate as N | mg/l | <1 |
| Oil & Grease | mg/l | <1.4 |
| Total Sulfides | mg/l | 1.8 |
| Calcium - Total | mg/l | <1 |
| Magnesium - Total | mg/l | <1 |
| Sodium - Total | mg/l | <1 |
| Potassium - Total | mg/l | <1 |
| Barium - Total | mg/l | <0.1 |
| Iron - Total | mg/l | <0.1 |
| Manganese - Total | mg/l | <0.05 |
| Strontium - Total | mg/l | <0.1 |
| Boron - Total | mg/l | 0.85 |

Table 3 clearly shows that the water treatment process employed in this example was able to reduce the levels of TDS from original 269,000 ppm to less than 5 ppm, TSS from original 712 ppm to 2 ppm, O&G from original 18.2 pm to less than 1.4 ppm, and TOC from original 1,200 ppm to 65 ppm. This result clearly illustrates the effectiveness of the water treatment method of the present disclosure.

Although specific embodiments and examples of the disclosure have been described supra for illustrative purposes, various equivalent modifications can be made without departing from its spirit and scope, as will be recognized by those skilled in the relevant art after reviewing the present disclosure. The various embodiments described can be combined to provide further embodiments. The described systems, devices and methods can omit some elements or acts, can add other elements or acts, or can combine the elements or execute the acts in a different order than that illustrated, to achieve various advantages of the invention. These and other changes can be made to the invention in light of the above detailed description. All changes and variations that fall within the meaning and range of equivalency of the claims are to be embraced within their scope.

In general, in the following claims, the terms used should not be construed to limit the disclosure to the specific embodiments disclosed in the specification.

1. A system for treating waste water comprising:
a waste water inlet;
a pretreatment system in fluid connection with the waste water inlet, the pretreatment system being adapted to reduce the concentration of at least one of suspended solids, oil and grease; and
a crystallization system downstream of the pretreatment system.

2. The system of claim 1 wherein water separated front sludge generated in the pretreatment system is recycled to the system and wherein water separated from a concentrate generated in the crystallization system is recycled to the system.

3. The system of claim 2 wherein the pretreatment system comprises at least one of an electrocoagulation system, a system for adding precipitating agents and flocculating agents followed by clarification, or a membrane filtration system.

4. The system of claim 2 wherein the crystallization system comprises a supersaturation generation system.

5. (canceled)

6. The system of claim 2 wherein the crystallization system comprises a magma recirculation system to control supersaturation generation.

7. The system of claim 2 wherein the crystallization system is configured such that a mixed suspension is provided as an active volume for relieving the supersaturation.

8. The system of claim 2 wherein the crystallization system is configured to be operated in a metastable zone of a solute-solvent system.

9. The system of claim 2 wherein the concentrate from the crystallization system is directed to a dewatering unit selected from the group consisting of a filter press system, a centrifuge system, and an electro-dewatering system.

10. The system of claim 2 further comprising a system adapted to adjust the pH of waste water entering the pretreatment system.

11. The system of claim 3 wherein the pretreatment system comprises the electrocoagulation system and wherein removed contaminants from the electrocoagulation system are fed into a sludge concentrator selected from the group consisting of a filter press system, a centrifuge system, and an electro-dewatering system.

12. The system of claim 3 further comprising a gravity separation unit for use in separating floating oil, floating grease or heavy suspended solids from the waste water before the waste water enters the at least one of the electrocoagulation system, the system for adding precipitating agents and flocculating agents followed by clarification, or the membrane filtration system.

13. The system of claim 12 wherein the gravity separation unit includes a baffled bank system, an oil-decanting port and a solid removal port.

14. The system of claim 3 further comprising a centrifugal separation unit located upstream of the at least one of the electrocoagulation system, the system for adding precipitating agents and flocculating agents followed by clarification, or the membrane filtration system.

15. The system of claim 3 further comprising a filtration unit located downstream of the at least one of the electrocoagulation system, the system for adding precipitating agents and flocculating agents followed by clarification, or the membrane filtration system but before the crystallization system.

16. The system of claim 3 wherein the system for adding precipitating agents and flocculating agents comprises a mixing tank connected to a precipitating tank from which precipitating agents are injected, and is connected to a flocculating agent tank from which a flocculating agent is injected.

17. (canceled)

18. A method for treating waste water comprising:
introducing the waste water into a pretreatment system being adapted to reduce the concentration of at least one of suspended solids, oil and grease; and
introducing liquid effluent from the pretreatment system to a crystallization system.

19. The method of claim 18 further comprising:
recycling water separated from sludge generated in the pretreatment system to the waste water introduced into the pretreatment system, or to another inlet; and
recycling water separated from a concentrate generated in the crystallization system to the crystallization system, or to another inlet.

20. The method of claim 19 wherein pretreatment in the pretreatment system comprises at least one of electrocoagulation, adding precipitating agents and flocculating agents followed by clarification, or a membrane filtration.

21. The method of claim 20 further comprising crystallizing a solute by providing a heating source to remove solvent from the liquid in the crystallization system.

22. The method of claim 21 further comprising controlling supersaturation generation using a magma recirculation system.

23. The method of claim 21 further comprising providing a mixed suspension as an active volume for relieving supersaturation.

24. The method of claim 21 wherein operating conditions during heating are within a metastable zone of a solute-solvent system in the crystallization system for a period of time.

25. The method of claim 21 wherein the concentrate from the crystallization system is directed to a dewatering system selected from the group consisting of a filter press system, a centrifuge system, and an electro-dewatering system.

26. The method of claim 20 further comprising adjusting the pH of waste water before it enters the pretreatment system.

30.-37. (canceled)

38. The method of claim 20 further comprising directing removed contaminants from the electrocoagulation system into a sludge concentrator selected from the group consisting of a filter press system, a centrifuge system, and an electro-dewatering system.

39. The method claim 20 further comprising separating at least one of floating oil, floating grease and or suspended solids from the waste water using a gravity separation system before the waste water enters the at least one of the electrocoagulation system, the system for adding precipitating agents and flocculating agents followed by clarification, or the membrane filtration system.
